(19) United States
(12) Patent Application Publication
(10) Pub. No.: US 2006/0022846 A1
(43) Pub. Date: Feb. 2, 2006

(54) Method for providing weather information to a mobile vehicle

(75) Inventor: Pavani Tummala, West Bloomfield, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/909,665

(22) Filed: Aug. 2, 2004

(51) Int. Cl. G08G 1/123; G06F 17/30; G08G 1/09

(52) U.S. Cl. 340/995.1; 340/905; 707/3

(57) ABSTRACT

A method of providing weather information to a mobile vehicle includes receiving a weather request including a GPS signal from the mobile vehicle at a call center, determining a map based on the GPS signal, associating at least one weather icon with the map and displaying the map with the icon at the vehicle.

### FIELD OF THE INVENTION

This invention relates generally to a telematics system weather indicator. In particular, the invention relates to a method, system and computer usable medium for displaying a weather indicator on a map in a mobile vehicle.

### BACKGROUND OF THE INVENTION

The opportunity to personalize features in a mobile vehicle is ever increasing as the automobile is being transformed into a communications and entertainment platform as well as a transportation platform. Many new cars are installed with some type of telematics unit to provide wireless communication and location-based services. These services may be accessed through interfaces such as voice-recognition computer applications, touch-screen computer displays, computer keyboards, or a series of buttons on the dashboard or console of a vehicle.

Currently, telematics service call centers, in-vehicle compact disk (CD) or digital video display (DVD) media, web portals, and voice-enabled phone portals provide various types of location services, including driving directions, stolen vehicle tracking, traffic information, weather reports, restaurant guides, ski reports, road condition information, accident updates, street routing, landmark guides, and business finders.

A traveler in a mobile vehicle often wants to know the weather conditions at their destination. A user who has such weather information is able to prepare, if necessary, for the weather conditions. For example, if the user is coming from an area of clear weather into an area with snow, the user can prepare by putting snow tires on the mobile vehicle or bring snow-chains for the tires. The radio broadcast in an area generally reports on the weather conditions only for the local region and the traveler must watch the television weather reports to learn about the weather in other areas.

A user often wants to know the predicted weather for an area in which they are driving. In that case, the user listens to local radio broadcasts for a weather forecast. Radio broadcasts of the weather on local radio stations are intermittent and often a user does not know when to expect a weather report. At times, the user does not want to listen to the radio but must do that to learn about the current and forecast weather conditions.

It is desirable, therefore, to provide a method, system and computer usable medium that overcomes the limitations described above. It is desirable to allow a driver of a mobile vehicle with an installed telematics system to obtain local and extended-area weather reports and to obtain the weather forecasts for the local area and an extended-area at any time.

### SUMMARY OF THE INVENTION

One aspect of the present invention provides a method of providing weather information to a mobile vehicle, the method including receiving a weather request including a GPS signal from the mobile vehicle at a call center, determining a map based on the GPS signal, associating at least one weather icon with the map and displaying the map with the icon at the vehicle.

Another aspect of the present invention provides a system to provide weather information to a mobile vehicle. The system includes means for receiving a weather request including a GPS signal from the mobile vehicle at a call center, means for determining a map based on the GPS signal, means for associating at least one weather icon with the map and means for displaying the map with the icon at the vehicle.

A third aspect of the present invention provides a computer readable medium storing a computer program which includes computer readable code for receiving a weather request including a GPS signal from the mobile vehicle at a call center, computer readable code for determining a map based on a GPS signal, computer readable code for associating at least one weather icon with the map and computer readable code for displaying the map with the icon at a mobile vehicle.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

Various embodiments of the present invention are illustrated by the accompanying figures, wherein:

FIG. 1 is a schematic diagram of a system for providing access to a telematics system in a mobile vehicle;

FIG. 2 illustrates a flowchart representative of a first embodiment of a method of providing weather information in accordance with the present invention;

FIG. 3 illustrates a flowchart representative of a method of determining a map in accordance with the present invention;

FIG. 4 illustrates a flowchart representative of a method of associating a weather icon with a map in accordance with the present invention;

FIG. 5 illustrates a flowchart representative of a method of displaying a map in accordance with the present invention;

FIG. 6 illustrates a flowchart representative of a first embodiment of method of retrieving a weather icon in accordance with the present invention;

FIG. 7 illustrates a flowchart representative of a second embodiment of a method of providing weather information in accordance with the present invention;

FIG. 8 illustrates a flowchart representative of a third embodiment of a method of providing weather information in accordance with the present invention; and

FIG. 9 illustrates a flowchart representative of a second embodiment of a method of retrieving a weather icon in accordance with the present invention.

### DETAILED DESCRIPTION OF THE PRESENTLY PREFERRED EMBODIMENTS

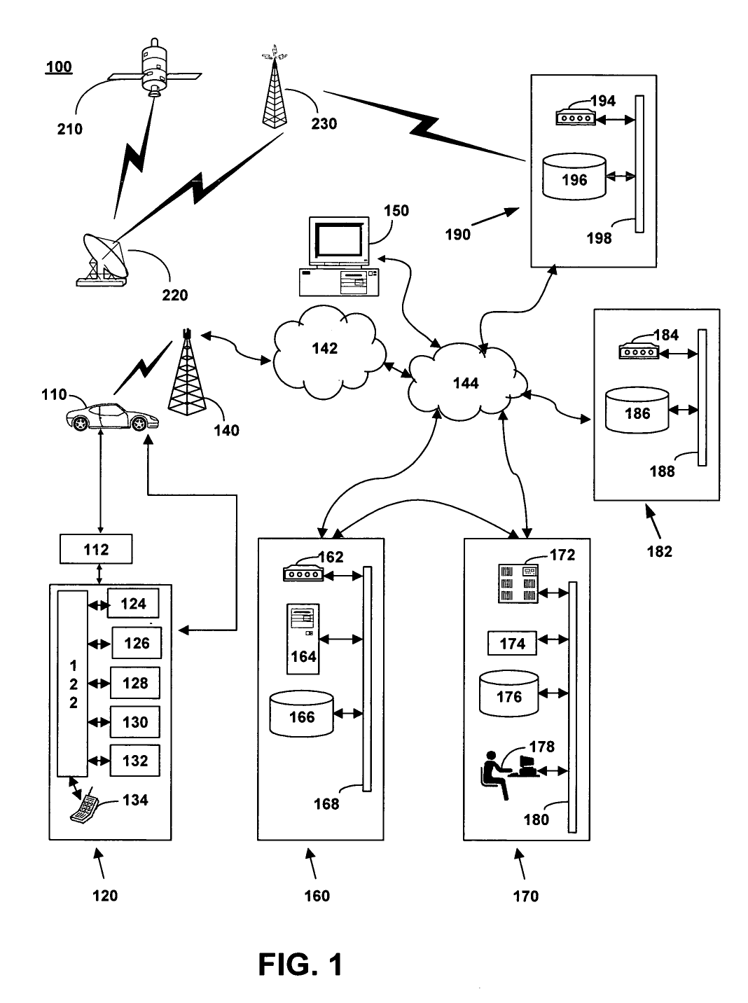

FIG. 1 illustrates one embodiment of system for data transmission over a wireless communication system, in accordance with the present invention at 100. Mobile vehicle communication system (MVCS) 100 includes a mobile vehicle communication unit (MVCU) 110, a vehicle communication network 112, a telematics unit 120, one or more wireless carrier systems 140, one or more communication networks 142, one or more land networks 144, one or more satellite radio service uplink facilities 220, one or more terrestrial radio transmitters 230, one or more satellites 210, one or more client, personal or user computers 150, one or more web-hosting portals 160, and one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 may also be referred to as a mobile vehicle throughout the discussion below. In operation, MVCU 110 may be implemented as a motor vehicle, a marine vehicle, or as an aircraft. MVCU 110 may include additional components not relevant to the present discussion.

MVCU 110, via a vehicle communication network 112, sends signals to various units of equipment and systems (detailed below) within MVCU 110 to perform various functions such as unlocking a door, opening the trunk, setting personal comfort settings, and calling from telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

MVCU 110, via telematics unit 120, sends and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (GPS) unit 126, an in-vehicle memory 128, a microphone 130, one or more speakers 132, and an embedded or in-vehicle mobile phone 134. In other embodiments, telematics unit 120 may be implemented without one or more of the above listed components, such as, for example GPS unit 126 or speakers 132. Telematics unit 120 may include additional components not relevant to the present discussion.

In one embodiment, processor 122 is a digital signal processor (DSP). Processor 122 is implemented as a microcontroller, microprocessor, controller, host processor, or vehicle communications processor. In an example, processor 122 is implemented as an application specific integrated circuit (ASIC). In another embodiment, processor 122 is implemented as a processor working in conjunction with a central processing unit (CPU) performing the function of a general purpose processor. GPS unit 126 provides longitude and latitude coordinates of the vehicle responsive to a GPS broadcast signal received from a one or more GPS satellite broadcast systems (not shown). In-vehicle mobile phone 134 is a cellular-type phone, such as, for example an analog, digital, dual-mode, dual-band, multi-mode or multi-band cellular phone.

Processor 122 executes various computer programs that control programming and operational modes of electronic and mechanical systems within MVCU 110. Processor 122 controls communications (e.g. call signals) between telematics unit 120, wireless carrier system 140, and call center 170. In one embodiment, a voice-recognition application is installed in processor 122 that can translate human voice input through microphone 130 to digital signals. Processor 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers. In this embodiment, signals from processor 122 are translated into voice messages and sent out through speaker 132.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, call center 170, map server 182, and weather server 190. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal or user computer 150 includes a computer usable medium to execute Internet browser and Internet-access computer programs for sending and receiving data over land network 144 and optionally, wired or wireless communication networks 142 to web-hosting portal 160. Personal or client computer 150 sends user preferences to web-hosting portal through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110. In operation, a client utilizes computer 150 to initiate setting or re-setting of user-preferences for MVCU 110. User-preference data from client-side software is transmitted to server-side software of web-hosting portal 160. User-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and from modem 162, data that is then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations and theft alarm settings. For each client, the web server potentially stores hundreds of preferences for wireless vehicle communication, networking, maintenance and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

A map server 182 includes one or more data modems 184, one or more databases 186, and a network system 188. Map server 182 is connected directly by wire to call center 170, or connected by phone lines to land network 144, which is connected to call center 170. In an example, map server 182 is connected to call center 170 utilizing an IP network. In this example, both map server 182 and call center 170, are connected to land network 144 utilizing the IP network. In another example, map server 182 is connected to land network 144 by one or more data modems 184. Land network 144 is in communication with modem 184. Land network 144 transmits data communications between map server 182 and call center 170. The databases 186 in map server 182 contain maps correlated to GPS signals. In one embodiment, the map data is located at external databases.

A weather server 190 includes one or more data modems 194, one or more databases 196, and a network system 198. Weather server 190 communicates with call center 170, either by a direct wired or wireless connection or through land network 144. In an example, weather server 190 is connected to call center 170 utilizing an IP network. In this example, both map server 182 and call center 170 are connected to land network 144 utilizing the IP network. In another example, weather server 190 is connected to land network 144 by one or more data modems 194. Land network 144 communicates with modem 194. Land network 144 transmits data communications between weather server 190 and call center 170.

The weather server 190 downloads weather data from one or more satellite radio service uplink facilities 220, one or more terrestrial radio transmitters 230 and one or more satellites 210. In one embodiment, weather data includes current weather data and weather data for extended time ranges, such as, weather data for the next five days. In one example, weather data for the next five days is available as five sets of weather data, in which each set is associated with a respective day of the next five days. The weather data is associated with a given geographical region correlated to a GPS signals. In one embodiment, map server 182 and weather server 190 are included in one server.

Call center 170 is a location where many calls are received and serviced at the same time, or where many calls are sent at the same time. In one embodiment, the call center is a telematics call center, facilitating communications to and from telematics unit 120 in MVCU 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services, including enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178.

In one embodiment, communication services advisor 178 is implemented as a real advisor. In an example, a real advisor is a human being in verbal communication with a user or subscriber (e.g. a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicate with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

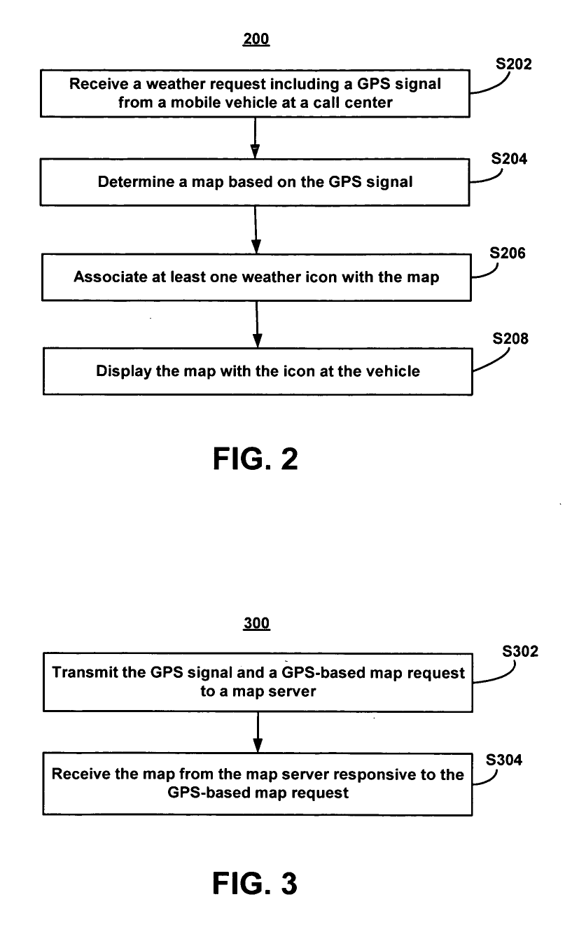

FIG. 2 illustrates a flowchart 200 representative of a first embodiment of a method of providing weather information in accordance with the present invention.

During stage S202, a weather request including a GPS signal is received from a MVCU 110 at a call center 170. The weather request is transmitted from the MVCU 110 in response to an activation of a vehicle weather request service. In one embodiment, the vehicle weather request service is activated with a button press in MVCU 110. For example, the weather option button push establishes a wireless communication link between the telematics unit 120 and the call center 170 and the weather request is transmitted over the open wireless communication link. The wireless communication link includes one or more wireless carrier systems 140, one or more communication networks 142, and/or one or more land networks 144. The GPS signal for the MVCU 110 is included in the weather request.

In one embodiment, the vehicle weather request service is activated by a verbal request from the user to a communication services advisor 178. The verbal request is established, in one embodiment, by pushing a different button in the telematics unit 120.

During stage S204, call center 170 determines a map based on the GPS signal. The determination is described in flowchart 300 of FIG. 3. In one embodiment, communication services manager 174 determines the map.

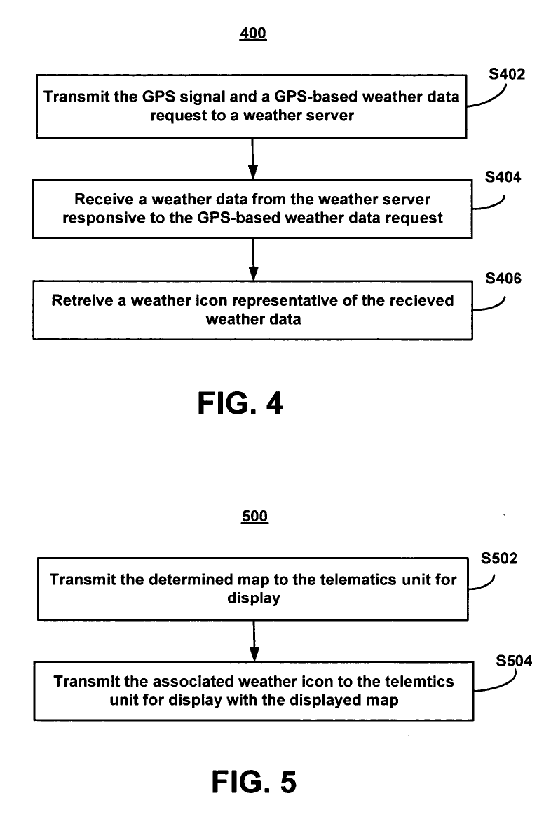

During stage S206, the call center 170 associates at least one weather icon with the map determined during stage S204. The association process is described in flowchart 400 of FIG. 4. A weather icon is a symbol that is representative of a type of weather. For example, clear weather with no clouds is symbolized with the weather icon of the sun, while rainy weather is symbolized with the weather icon of a raindrop.

During stage S208, the determined map and the weather icon associated with the map during stage S206 are displayed on a display at the MVCU 110. The displaying process is described in flowchart 500 of FIG. 5.

FIG. 3 illustrates a flowchart 300 representative of a method of determining a map in accordance with the present invention. During stage S302, the call center 170 transmits a GPS-based map request along with the GPS signal from the MVCU 110, which was received with the weather request of stage S202 in FIG. 2 to the map server 182.

When the map server 182 receives the GPS-based map request the map server 182 retrieves a map for the area in a defined radius from the geographical point indicated by the GPS signal. The defined radius is preset. In one embodiment, the radius is defined by a radius input from the user of MVCU 110. In another embodiment, the radius is defined by a radius input from the call center 170. In one embodiment, the radius is dynamically determined in response to the geographical density of the area as determined from a data source such as census data. The dynamic determination is made by map server 182, in one embodiment. In another embodiment, the dynamic determination is made by the telematics unit 120. Other factors to dynamically determine the radius include the vehicle velocity, and vehicle destination. In another embodiment, user profile and preferences are entered using a web portal (e.g. 160 of FIG. 1). In another embodiment, road topography, as determined by a digital map database is a factor for the dynamic determination.

Maps based on a GPS signal are commercially available, as known to those of ordinary skill in the art. For example, NavTeq of Chicago, Ill., offers a navigational service to provide maps for a geographical area related to a GPS signal.

During stage S304, the call center 170 receives the map from the map server 182 responsive to the GPS-based map request. In one embodiment, the map is a text file including a digital input required to display the map on a display.

FIG. 4 illustrates a flowchart 400 representative of a method of associating a weather icon with a map in accordance with the present invention. During stage S402, the call center 170 transmits a GPS-based weather data request along with the GPS signal for MVCU 110, which was received with the weather request of stage S202 in FIG. 2 to the weather server 190.

When the weather server 190 receives the GPS-based weather data request, the weather server 190 downloads the weather code for the geographical point indicated by the GPS signal. In one embodiment, weather codes including weather data for geographical regions, are broadcast from satellites 210. In one embodiment, the weather code from the satellite 210 is the weather data transmitted by the weather server 190 to the call center 170.

In one embodiment, the weather server 190 transmits a request to retrieve weather code for a particular GPS-based location to a satellite 210. The weather server 190 transmits the request for weather codes to the satellite via communications links including one or more satellite radio service uplink facilities 220, one or more terrestrial radio transmitters 230, one or more satellites 210, one or more wireless carrier systems 140, one or more communication networks 142, one or more land networks 144. When the weather server 190 receives the requested weather code, the weather server 190 extracts the weather data for the geographical area. The weather server 190 transmits the received weather data to the call center 170.

In one embodiment, the weather server 190 continuously receives current and predicted weather codes from the satellite 210 for many regions. The weather server 190 stores the location based weather codes in updated databases 196 and updates the weather codes as new input is received for a geographic location. In this embodiment, when the weather server 190 receives GPS-based weather data request, the weather server 190 downloads weather code from the database 196 of current and predicted weather codes. Then the weather server 190 extracts the weather data for the geographical area using processors located in the weather server 190 and transmits the weather data to the call center 170.

In one embodiment, the weather code for a geographical area related to a GPS signal is downloaded from satellite 210 by the call center 170 in response to a weather request from a user of a telematics unit 120. In that case, the call center 170 extracts the weather data for the geographical area. In one embodiment, the communication services manager 174 extracts the weather data.

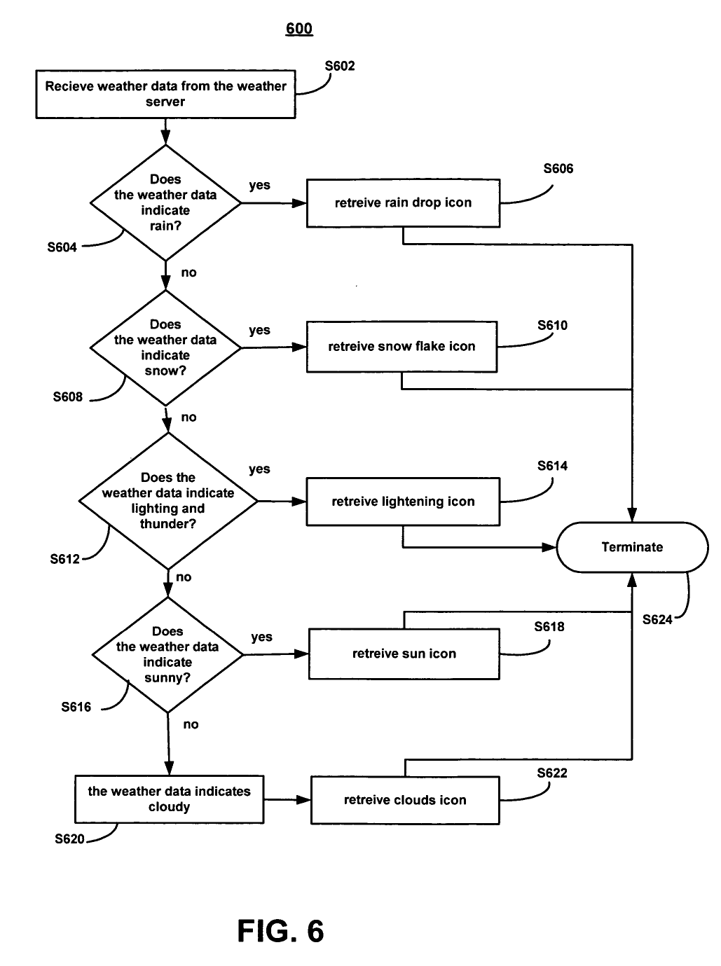

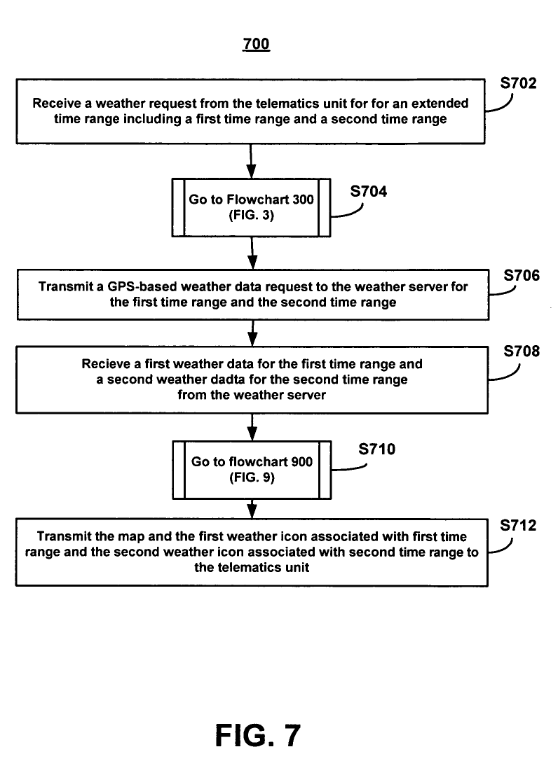

During stage S404, the call center 170 receives the weather data from the weather server 190 responsive to the GPS-based weather data request. In one embodiment, the weather data is a digital text file. During stage S406, the communication services manager 174 in call center 170 retrieves a weather icon representative of the received weather data. In one embodiment, the icons are stored in one or more communication services databases 176. The weather icon is a symbol that is recognized as representing a type of weather. The process used to retrieve the weather icon is described in flowchart 600 of FIG. 6.

FIG. 5 illustrates a flowchart 500 representative of a method of displaying a map with an associated weather icon in accordance with the present invention. During stage S502, the call center 170 transmits the determined map to the telematics unit 120 for display in the MVCU 110. The call center 170 establishes a wireless communication link between the telematics unit 120 and the call center 170 and the determined map is transmitted over the open wireless communication link. The wireless communication link includes one or more wireless carrier systems 140, one or more communication networks 142, and/or one or more land networks 144.

During stage S504, the call center 170 transmits the weather icon associated with the transmitted map to the telematics unit 120 for display with the map in the MVCU 110. The weather icon is transmitted via the established wireless communication link. The weather icon is displayed on the transmitted map. In one embodiment, the weather icon is displayed near the transmitted map. The weather icon is representative of the received weather data to indicate the weather conditions for the area shown on the determined map. The display in MVCU 110 is any visual display, such as a monitor or heads-up display.

FIG. 6 illustrates a flowchart 600 representative of a method of retrieving a weather icon in accordance with the present invention. During stage S602, the communication services manager 174 of the call center 170 receives a weather data from the weather server 190 as described during stage S404 of flowchart 400 in FIG. 4. In order to determine what weather is indicated by the weather data, the communication services manager 174 compares the received weather data with all possible-weather data that are stored in the communications services databases 176 until a match is determined. Each possible-weather data is correlated with a weather icon. In one embodiment, the possible-weather data is stored in a table and linked to a respective weather icon.

During stage S604, communication services manager 174 determines if the weather data indicates rain. In order to determine if the weather data indicates rain, communication services manager 174 compares the received weather data with a rain weather data that is stored in the communications services databases 176 and correlated with a rain drop icon. If it is determined during stage S604, that the received weather data matches the weather data indicative of rain, the flow proceeds to stage S606. During stage S606, the communication services manager 174 retrieves the correlated rain drop icon. The flow proceeds to stage S624 where the flow is terminated.

If it is determined during stage S604, that the received weather data does not indicate rain, the flow proceeds to stage S608. During stage S608, communication services manager 174 determines if the weather data indicates snow by comparing the received weather data with a snow weather data stored in the communications services databases 176 and correlated with a snow flake icon. If it is determined during stage S608, that the received weather data matches the weather data indicative of snow, the flow proceeds to stage S610. During stage S610, the communication services manager 174 retrieves the correlated snow flake icon. The flow proceeds to stage S624 where the flow is terminated.

If it is determined during stage S608, that the received weather data does not indicate snow, the flow proceeds to stage S612. During stage S612, communication services manager 174 determines if the weather data indicates thunder and lightning by comparing the received weather data with a thunder and lightning weather data stored in the communications services databases 176 and correlated with a lighting icon. If it is determined that the received weather data matches the weather data indicative of thunder and lightning, the flow proceeds to stage S614. During stage S614, the communication services manager 174 retrieves the correlated lightning icon. The flow proceeds to stage S624 where the flow is terminated.

If it is determined during stage S612, that the received weather data does not indicate thunder and lightning, the flow proceeds to stage S616. During stage S616, communication services manager 174 determines if the weather data indicates sunny by comparing the received weather data with sunny weather data stored in the communications services databases 176 and correlated with a sun icon. If it is determined during stage S616, that the received weather data matches the weather data indicative of sunny, the flow proceeds to stage S618. During stage S618, the communication services manager 174 retrieves the correlated sun icon. The flow proceeds to stage S624 where the flow is terminated.

If it is determined during stage S616, that the received weather data does not indicate sunny, the flow proceeds to stage S620. During stage S620, communication services manager 174 confirms the weather data indicates cloudy since, in this exemplary case, cloudy is the last possible-weather data that can be received. The communication services manager 174 confirms that the weather data indicates cloudy by comparing the received weather data with cloudy weather data stored in the communications services databases 176.

The flow proceeds to stage S622. During stage S622, the communication services manager 174 retrieves the correlated clouds icon. The flow proceeds to stage S624 where the flow is terminated.

This list, as well as the order of the method steps, of weather conditions is exemplary and many more such weather conditions and representative weather icons are potentially included in the table, including weather data for high winds, sleet, hail, tornados, hurricanes, etc. In addition levels of partly sunny and partly cloudy are possible-weather data conditions with representative icons to be included in the table. In one embodiment, two or more weather data are retrieved for one location.

In one embodiment, the weather server 190 retrieves the weather icon and transmits the weather icon to the call center 170. In another embodiment, the table including the weather data and linked weather icons is stored in the memory 128 of the telematics unit 120. In that case, the call center 170 transmits the weather data to the telematics unit 120 and the processor 122 then retrieves the weather icon for display with the determined map.

FIG. 7 illustrates a flowchart 700 representative of a second embodiment of a method of providing weather information in accordance with the present invention. In this embodiment, the user of the telematics unit 120 selects to view a map with weather icons indicating the weather forecast for an extended time range.

During stage S702, the call center 170 receives a weather request from the telematics unit 120 for an extended time range including a first time range and a second time range. The weather request also includes the GPS signal received from a MVCU 110 at a call center 170. The extended time range weather request is transmitted from the MVCU 110 in response to an activation of a vehicle weather request service. The user indicates the extended time ranges by a second button push. The second button push prompts the user to select the desired time ranges. The desired time ranges can be selected by a sequence of keystrokes on the display or a keypad in the telematics unit 120 or by verbally requesting the extended time range when speaking with a communication services advisor 178.

In one embodiment, a user, who currently has a map and weather icon on display in the MVCU 120 may select to view the map with extended time ranges. This selection requires a button push that is operable to prompt the user to select the desired time ranges.

During stage S704, the flow proceeds to flowchart 300 in FIG. 3 while the call center 170 transmits the GPS signal and a GPS-based map request to the map server 182 and the call center 170 receives the map from the map server 182 responsive to the GPS-based map request.

Stage S704 is not required for the embodiment in which the user has the map currently displayed at the vehicle MVCU 120. In this embodiment, the weather request received at the call center 170 is configured to indicate that only the weather icons for the extended time are required.

During stage S706, the call center 170 transmits a GPS-based weather data request for the first time range and second time range. The GPS-based weather data request also includes the GPS signal of the MVCU 110. When the weather server 190 receives the GPS-based weather data request with the first time range, second time range, the weather server 190 downloads forecast-weather codes for selected time frames for the geographical point indicated by the GPS signal from the satellite 210.

In one embodiment, the weather server 190 obtains forecast-weather codes for selected time frames for the geographical point indicated by the GPS signal from updated databases 196 in weather server 190.

The weather server 190 obtains the weather codes and extracts the weather data for the first and second time ranges. Then the weather server 190 transmits the GPS-based weather data for the first time range and the second time range to the telematics unit 120. The weather server 190 transmission includes data to indicate which weather data is for which time range.

During stage S708, the call center 170 receives the GPS-based weather data for the first time range and the second time range from the weather server 190 responsive to the GPS-based weather data request.

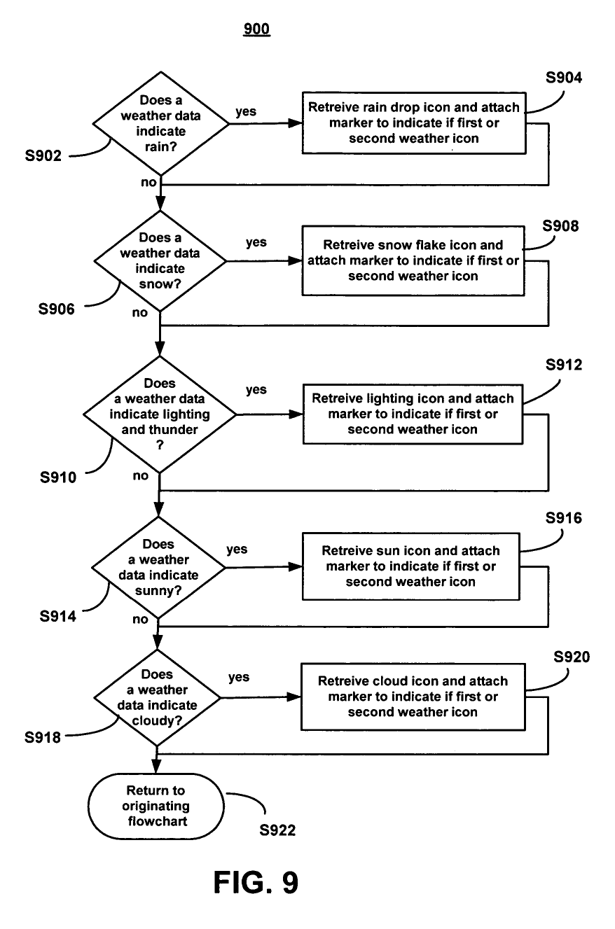

During stage S710, the flow proceeds to flowchart 900 in FIG. 9. Flow chart 900 describes the method by which the communication services manager 174 in call center 170 retrieves a first weather icon representative of the first weather data and a second weather icon representative of the second weather data.

During stage S712, the call center 170 transmits the determined map and the first weather icon associated with first time range and the second weather icon associated with second time range to the telematics unit 120 for display. The call center 170 establishes a wireless communication link between the telematics unit 120 and the call center 170. Then the map, the first weather icon and the second weather icon are transmitted via the established wireless communication link. The wireless communication link includes one or more wireless carrier systems 140, one or more communication networks 142, and one or more land networks 144.

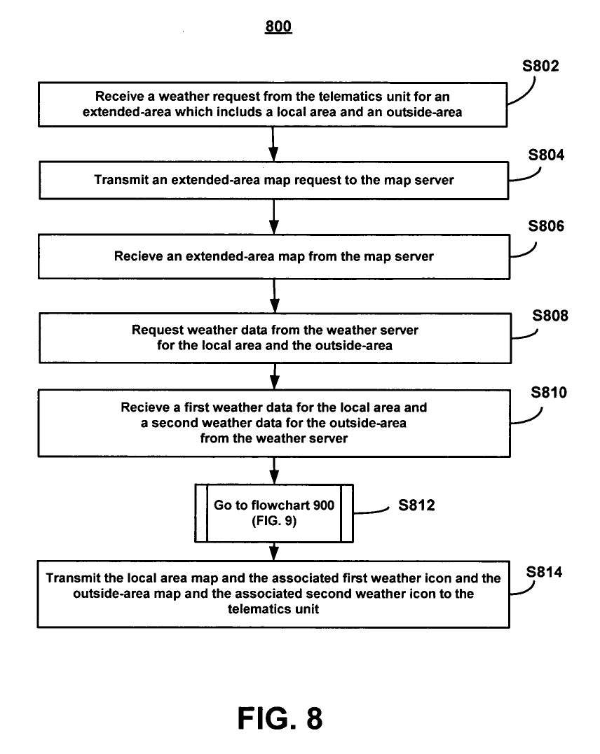

FIG. 8 illustrates a flowchart 800 representative of a third embodiment of a method of providing weather information in accordance with the present invention. In this embodiment, the user of the telematics unit 120 selects to view the weather icons associated with an extended-area map that includes a local area map and an outside-area map.

During stage S802, the call center 170 receives a weather request for an extended-area, which includes the local area and the outside-area. The extended-area weather request includes a GPS signal, a local area GPS signal and an outside-area indicator. The outside-area indicator includes an outside-point and an outside-radius. The weather request is transmitted from the MVCU 110 in response to the user activating a vehicle weather request service for an extended-area.

The local area includes the area within a local-radius centered about the geographical point indicated by the GPS signal. The user selects the outside-area. To select the outside-area, the user scrolls on the displayed map to a desired outside-area. The outside-area includes the area within an outside-radius centered about the outside-point. To select the outside-point, the user pushes a button when the desired outside-point is centered in the users displayed map. The user selects the outside-radius by a sequence of keystrokes on the display or a keypad in the telematics unit 120 or by verbally specifying the outside-radius when speaking with a communication services advisor 178. The processor 120 of telematics unit 120 configures the outside-point and the outside-radius to form the outside-area indicator.

If the outside-area is beyond the scrolled map displayed in the MCVU 110, the user contacts a communication services advisor 178 to transmit the extended-area weather request. In that case, the user selects the outside-area verbally. Then the communication services advisor 178 establishes longitude and latitude coordinates of the outside-point to configure the outside indicator as an outside-area GPS signal.

In one embodiment, the local area overlaps the outside-area. In another embodiment, the local area does not overlap the outside-area. In an exemplary situation, the user selects the extended-area to include two cities: the user's local city and a second city separated from the local city by a distance greater than the local-radius. In one embodiment, the user selects that the extended-area include the area between the local area city and the second city. In another embodiment, the user selects that the extended-area not include the area between the local area city and the second city.

In one embodiment, the outside-radius equals the local-radius. In one embodiment, the outside-radius is a default radius, which can be over-ridden by a sequence of keystrokes on the display or a keypad in the telematics unit 120 or by verbally specifying the outside-radius when speaking with a communication services advisor 178.

During stage S804, the call center 170 transmits a GPS-based extended-area map request to the map server 182. The GPS-based extended-area map request includes an extended-area map request, the GPS signal of the MVCU 110 and the outside-area indicator. The extended-area map request includes a request for at least two maps: one map of the local area around the geographical point indicated by the GPS signal and another map of the outside-area around the geographical outside-point selected by the user. When the map server 182 receives the GPS-based extended-area map request, the map server 182 retrieves a map for the local area and a map for the outside-area. The local-radius is, in one embodiment, the same radius described during stage S302 in flowchart 300 of FIG. 3.

The map server 182 uses the outside-point location to determine an outside-area GPS signal. The outside-area map is then retrieved using the outside-area GPS signal as described during stage S302 in flowchart 300 of FIG. 3.

In one embodiment, the call center 170 uses the outside-point location to determine an outside-area GPS signal. In that case, the outside-area GPS signal is used to configure the outside-area indicator as an outside-area GPS signal.

During stage S806, the call center 170 receives the extended-area map from the map server 182 responsive to the GPS-based extended-area map request. In one embodiment, the extended-area map includes two maps: a local area map and an outside-area map. The extended-area map is, in one embodiment, a text file including a digital input required to display the map on a display. The map server 182 transmits the outside-area GPS to the call center 170, responsive to the outside-area indicator.

During stage S808, the call center 170 transmits a GPS-based weather data request for the local area associated with the GPS signal for MVCU 110 and for the outside-area associated with the outside-area GPS signal. As described above for stage S420 in flowchart 400 of FIG. 4, weather server 190 downloads weather codes for the geographical points indicated by the GPS signal and the outside-area GPS signal. The weather codes are obtained from the satellite 210 or from updated databases 196. The weather server 190 obtains the weather codes and extracts the weather data for the local area and for the outside-area. Then the weather server 190 transmits the GPS-based first weather data for the local area and the outside-area GPS-based second weather data for the outside-area to the call center 110. The weather server 190 transmission includes a marker to indicate which weather data is for which geographical region.

During stage S810, the call center 170 receives the first weather data and second weather data for the local area and the outside-area, respectively, from the weather server 190 responsive to the GPS-based weather data request for the local area and the outside-area.

During stage S812, the flow proceeds to flowchart 900 in FIG. 9. Flow chart 900 describes the method by which the communication services manager 174 in call center 170 retrieves a first weather icon representative of the first weather data and a second weather icon representative of the second weather data.

During stage S814, the call center 170 transmits the local area map and the associated first weather icon associated to the telematics unit 120 for display. The call center 170 also transmits the outside-area map and the associated second weather icon to the telematics unit 120 for display.

The call center 170 establishes a wireless communication link between the telematics unit 120 and the call center 170. The map, the first weather icon and the second weather icon are transmitted via the established wireless communication link. The wireless communication link includes one or more wireless carrier systems 140, one or more communication networks 142, and/or one or more land networks 144.

In one embodiment, the local area map and the outside-area map are displayed as one continuous map with weather icons over the associated areas. In another embodiment, the local area map and the outside-area map are displayed as two separate maps with the associated weather icons.

FIG. 9 illustrates a flowchart 900 representative of a method of retrieving the first weather icon and the second weather icon for the in accordance with the present invention. In order to determine what weather is indicated by the weather data, the communication services manager 174 compares the first weather data and the second weather data with possible-weather data that are stored in the communications services databases 176. Each possible-weather data is correlated with a weather icon. In one embodiment, the possible-weather data is stored in a table and linked to a respective weather icon.

During stage S902, communication services manager 174 determines if the first weather data and/or the second weather data indicate rain. The communication services manager 174 compares the first weather data and the second weather data with a rain weather data stored in the communications services databases 176 and correlated with a rain drop icon. If it is determined during stage S902, that either or both of received the first weather data and the second weather data match the weather data indicative of rain, the flow proceeds to stage S904. During stage S904, the communication services manager 174 retrieves the rain drop icon and attaches a marker to indicate if the weather icon is a first weather icon or a second weather icon. The marker associates the weather icon with the respective time frame. The flow proceeds to stage S906.

If it is determined during stage S902, that both the first weather data and the second weather data do not indicate rain, the flow proceeds to stage S906. During stage S906, communication services manager 174 determines if the first weather data and/or the second weather data indicate snow. The communication services manager 174 compares the first weather data and the second weather data with a snow weather data that is stored in the communications services databases 176 and correlated with a snow flake icon. If it is determined during stage S906, that either or both of received the first weather data and the second weather data match the weather data indicative of snow, the flow proceeds to stage S908. During stage S908, the communication services manager 174 retrieves the snow flake icon from the table and attaches a marker to indicate if the weather icon is a first weather icon or a second weather icon. The flow proceeds to stage S910.

If it is determined during stage S906, that both the first weather data and the second weather data do not indicate snow, the flow proceeds to stage S910. During stage S910, communication services manager 174 determines if the first weather data and/or the second weather data indicate thunder and lightning. The communication services manager 174 compares the first weather data and the second weather data with a thunder and lightning weather data that is stored in the communications services databases 176 and correlated with a lighting icon. If it is determined that either or both of received the first weather data and the second weather data match the weather data indicative of thunder and lightning, the flow proceeds to stage S912. During stage S912, the communication services manager 174 retrieves the lightning icon from the table and attaches a marker to indicate if the weather icon is a first weather icon or a second weather icon. The flow proceeds to stage S914.

If it is determined during stage S910, that both the first weather data and the second weather data do not indicate thunder and lightning, the flow proceeds to stage S914. During stage S914, communication services manager 174 determines if the first weather data and/or the second weather data indicate sunny weather. The communication services manager 174 compares the first weather data and the second weather data with sunny weather data that is stored in the communications services databases 176 and correlated with a sun icon. If it is determined during stage S914, that either or both of received the first weather data and the second weather data match the weather data indicative of sunny, the flow proceeds to stage S916. During stage S916, the communication services manager 174 retrieves the sun icon from the table. The flow proceeds to stage S918.

If it is determined during stage S914, that the both the first weather data and the second weather data do not indicate sunny, the flow proceeds to stage S918. During stage S918, communication services manager 174 determines if the first weather data and/or the second weather data indicate cloudy weather. The communication services manager 174 compares the first weather data and the second weather data with cloudy weather data that is stored in the communications services databases 176 and correlated with a clouds icon. If it is determined during stage S914, that either or both of received the first weather data and the second weather data match the weather data indicative of cloudy, the flow proceeds to stage S920. During stage S920, the communication services manager 174 retrieves the clouds icon. The flow proceeds to stage S922.

If it is determined during stage S918, that both the first weather data and the second weather data do not indicate cloudy, the flow proceeds to stage S922. During stage S922, the flow returns to the originating flowchart. If the user of the telematics unit 120 selects to view a map with weather icons for weather forecast for a time range in the future, the flow returns to stage S712 of flow chart 700 in FIG. 7. If the user of the telematics unit 120 selects to view an extended-map, the flow returns to stage S914 of flowchart 800 in FIG. 8.

In one embodiment, a displayed icon of any of the disclosed methods is displayed with an associated time. For example, a rain icon is displayed with an associated time indicating that the rain forecast extends from 2-4 PM.

This method is operable to retrieve weather icons for more than two weather data. In one embodiment, the user requests an extended map with a weather forecast having an extended time range for both the local area map and the outside-area map.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of providing weather information to a mobile vehicle, the method comprising:
receiving a weather request including a GPS signal from the mobile vehicle at a call center;
determining a map based on the GPS signal;
associating at least one weather icon with the map; and
displaying the map with the icon at the vehicle.

2. The method of claim 1, wherein the weather request is transmitted from the vehicle responsive to an activation of a vehicle weather request service over a wireless communication link established responsive to the activation.

3. The method of claim 2, wherein the activation of a vehicle weather request service includes pushing a weather option button in the vehicle.

4. The method of claim 1, wherein the determining comprises:
transmitting the GPS signal and a GPS-based map request to a map server; and
receiving the map from the map server responsive to the GPS-based map request.

5. The method of claim 4, wherein the GPS-based map request comprises a request for an extended-area map.

6. The method of claim 1, wherein the associating comprises:
transmitting the GPS signal and a GPS-based weather data request to a weather server; and
receiving a weather data from the weather server responsive to the GPS-based weather data request.

7. The method of claim 6, wherein the associating further comprises:
retrieving a weather icon representative of the received weather data.

8. The method of claim 6, wherein the GPS-based weather data request comprises a request for weather data for an extended time range.

9. The method of claim 6, wherein the weather server includes a map server.

10. The method of claim 1, wherein displaying the map with the icon at the vehicle comprises:
transmitting the determined map to a telematics unit for display; and
transmitting the associated weather icon to the telematics unit for display with the displayed map.

11. The method of claim 1, wherein the icon on the displayed map includes more than one icon and wherein each icon is displayed with an associated time.

12. The method of claim 1, wherein the icon on the displayed map includes at least one icon for a weather forecast for an extended-area.

13. A system to provide weather information to a mobile vehicle, the system comprising:
means for receiving a weather request including a GPS signal from the mobile vehicle at a call center;
means for determining a map based on the GPS signal;
means for associating at least one weather icon with the map; and
means for displaying the map with the icon at the vehicle.

14. The system of claim 13, wherein the means for determining comprises:
means for transmitting the GPS signal and a GPS-based map request to a map server; and
means for receiving the map from the map server responsive to the GPS-based map request.

15. The system of claim 13, wherein the means for associating comprises:
means for transmitting the GPS signal and a GPS-based weather data request to a weather server; and
means for receiving a weather data from the weather server responsive to the GPS-based weather data request.

16. The system of claims 13, wherein the means for displaying comprises:
means for transmitting determined map to a telematics unit for display; and
means for transmitting the associated weather icon to the telematics unit for display with the displayed map.

17. A computer readable medium storing a computer program comprising:
computer readable code for determining a map based on a GPS signal;
computer readable code for associating at least one weather icon with the map; and
computer readable code for displaying the map with the icon at a mobile vehicle.

18. The medium of claim 17, wherein the computer readable code for determining comprises:
computer readable code for transmitting the GPS signal and a GPS-based map request to a map server; and
computer readable code for receiving the map from the map server responsive to the GPS-based map request.

19. The medium of claim 17, wherein the computer readable code for associating comprises:
computer readable code for transmitting the GPS signal and a GPS-based weather data request to a weather server; and
computer readable code for receiving a weather data from the weather server responsive to the GPS-based weather data request.

20. The medium of claim 17, wherein the computer readable code for displaying comprises:
computer readable code for transmitting the weather icon to a telematics unit; and
computer readable code for transmitting the determined map to the telematics unit.
